(19) United States
(12) Patent Application Publication
(10) Pub. No.: US 2026/0206088 A1
(43) Pub. Date: Jul. 16, 2026

(54) COMMUNICATION METHOD, ELECTRONIC DEVICE, AND STORAGE MEDIUM

(71) Applicant: BEIJING XIAOMI MOBILE SOFTWARE CO., LTD., Beijing (CN)

(72) Inventor: Yajun CHENG, Beijing (CN)

(73) Assignee: BEIJING XIAOMI MOBILE SOFTWARE CO., LTD., Beijing (CN)

(21) Appl. No.: 19/138,046

(22) PCT Filed: Dec. 12, 2022
(86) PCT No.: PCT/CN2022/138494

§ 371 Date: Jun. 11, 2025

(51) Int. Cl. H04W 76/20

(52) U.S. Cl. CPC H04W 76/20

(57) ABSTRACT

The present disclosure relates to the technical field of mobile communications, and provide a communication method, an electronic device, and a storage medium. The communication method is applied to a multi-link access device AP MLD. The method comprises: determining a first frame, wherein the first frame comprises first identifier information, the first identifier information instructs whether to map a target Traffic Identifier TID to a newly added link between an AP MLD and a multi-link station device Non-AP MLD, and the newly added link is a link newly added to setup links after negotiation and Multi-Link (ML) setup procedures between the AP MLD and the Non-AP MLD; and sending the first frame.

### CROSS REFERENCE

The present application is a national phase application of International Application No. PCT/CN2022/138494, filed on Dec. 12, 2022, and the entire contents of which are incorporated herein by reference.

### TECHNICAL FIELD

The embodiments of the present disclosure relate to the field of mobile communication technology. Specifically, the embodiments of the present disclosure relate to a communication method, an electronic device, and a storage medium.

### BACKGROUND

To achieve higher throughput, lower network latency and higher reliability, the Multi-Link Operation (MLO) mechanism is introduced into Wi-Fi technology. Devices that support the MLO function are called Multi-Link Devices (MLD). With the help of MLO technology, multiple links can be established across frequency bands between multi-link access point devices (AP MLD) and multi-link site devices (Non-AP MLD). MLO can not only effectively improve system throughput, but also reduce network latency, packet loss rate and improve communication reliability by simultaneously detecting and selecting the best link or dynamically switching links.

In the MLO mechanism, after negotiation and Multi-Link (ML) setup procedures between the AP MLD and the Non-AP MLD, a new link may be added.

It should be noted that, information disclosed in the above background portion is provided only for better understanding of the background of the present disclosure, and thus it may contain information that does not form the prior art known by those ordinary skilled in the art.

### SUMMARY

The embodiments of the present disclosure provide a communication method, an electronic device, and a storage medium.

In one aspect, an embodiment of the present disclosure provides a communication method, which is applied to a multi-link access point device (AP MLD), and the method includes:
determining a first frame; wherein the first frame includes first identification information, and the first identification information indicates whether to map a target Traffic Identifier (TID) to a newly added link between the AP MLD and a multi-link site device (Non-AP MLD); the newly added link is a link newly added to setup links after negotiation and Multi-Link (ML) setup procedures between the AP MLD and the Non-AP MLD; and
sending the first frame.

In another aspect, an embodiment of the present disclosure further provides a communication method, applied to a multi-link site device (Non-AP MLD), and the method includes:
receiving a first frame; wherein the first frame includes first identification information, and the first identification information indicates whether to map a target Traffic Identifier (TID) to a newly added link between the Non-AP MLD and a multi-link access point device (AP MLD); the newly added link is a link newly added to setup links after negotiation and Multi-Link (ML) setup procedures between the AP MLD and the Non-AP MLD.

In another aspect, an embodiment of the present disclosure further provides an electronic device, wherein the electronic device is a multi-link access point device (AP MLD), wherein the electronic device includes:
a determining module, configured to determine a first frame; wherein the first frame includes first identification information, and the first identification information indicates whether to map a target Traffic Identifier (TID) to a newly added link between the AP MLD and a multi-link site device (Non-AP MLD); the newly added link is a link newly added to setup links after negotiation and Multi-Link (ML) setup procedures between the AP MLD and the Non-AP MLD; and
a sending module, configured to send the first frame.

In another aspect, an embodiment of the present disclosure further provides an electronic device, wherein the electronic device is a multi-link site device (Non-AP MLD), wherein the electronic device includes:
a receiving module, configured to receive a first frame; wherein the first frame includes first identification information, and the first identification information indicates whether to map a target Traffic Identifier (TID) to a newly added link between the Non-AP MLD and a multi-link access point device (AP MLD); the newly added link is a link newly added to setup links after negotiation and Multi-Link (ML) setup procedures between the AP MLD and the Non-AP MLD.

In another aspect, an embodiment of the present disclosure further provides an electronic device, includes a memory, a processor, and a computer program stored in the memory and executable on the processor, wherein when the program is executed by the processor, one or more of the methods according to the embodiments of the present disclosure are implemented.

In another aspect, an embodiment of the present disclosure further provides a computer-readable storage medium, wherein the computer-readable storage medium is stored with a computer program, and when the program is executed by a processor, one or more of the methods according to the embodiments of the present disclosure are implemented.

Additional aspects and advantages of the embodiments of the present disclosure will be partially given in the description below, which will become apparent from the description below, or will be learned through the practice of the present disclosure.

It is to be understood that both the foregoing general description and the following detailed description are exemplary and explanatory only and are not restrictive of the present disclosure.

### BRIEF DESCRIPTION OF THE DRAWINGS

In order to more clearly illustrate the technical solutions of the embodiments of the present disclosure, the drawings required for use in the description of the embodiments of the present disclosure will be briefly introduced below. Obviously, the drawings in the following description are only some embodiments of the present disclosure. For those skilled in the art, other drawings can be obtained based on these drawings without creative work.

FIG. 1 is a first flow chart of a communication method according to an embodiment of the present disclosure;

FIG. 2 is a first schematic diagram of a first example of an embodiment of the present disclosure;

FIG. 3 is a second schematic diagram of the first example of the embodiment of the present disclosure;

FIG. 4 is a second flowchart of the communication method provided in an embodiment of the present disclosure;

FIG. 5 is a first structural schematic diagram of an electronic device provided by an embodiment of the present disclosure;

FIG. 6 is a second structural schematic diagram of the electronic device provided by an embodiment of the present disclosure; and

FIG. 7 is a third structural schematic diagram of the electronic device provided by an embodiment of the present disclosure.

### DETAILED DESCRIPTION

Exemplary embodiments will be described in detail herein, examples of which are shown in the accompanying drawings. Unless otherwise indicated, when the following description refers to the drawings, the same numbers in different drawings represent the same or similar elements. The embodiments described in the following exemplary embodiments do not represent all embodiments consistent with the present invention. Instead, they are merely examples of devices and methods consistent with some aspects of the present invention as detailed in the appended claims.

In the embodiments of the present disclosure, the terms used are only for the purpose of describing specific embodiments and are not intended to limit the present disclosure. The singular forms of “a”, “said” and “the” used in the present disclosure and the appended claims are also intended to include plural forms, unless the context clearly indicates other meanings. It should also be understood that the term “and/or” used in this article refers to and includes any or all possible combinations of one or more associated listed items. For example, A and/or B can represent: A exists alone, A and B exist at the same time, and B exists alone. The character “/” generally indicates that the objects associated before and after are in an “or” relationship. The term “multiple” refers to two or more. In view of this, “multiple” can also be understood as “at least two” in the embodiments of the present disclosure.

It should be understood that although the terms first, second, third, etc. may be used in the present disclosure to describe various information, such information should not be limited to these terms. These terms are only used to distinguish the same type of information from each other. For example, without departing from the scope of the present disclosure, the first information may also be referred to as the second information, and similarly, the second information may also be referred to as the first information. Depending on the context, for example, the word “if” used herein may be interpreted as “at the time of” or “when” or “in response to determining”.

Hereinafter, the technical solutions in the embodiments of the present disclosure will be clearly and completely described in conjunction with the drawings in the embodiments of the present disclosure. Obviously, the described embodiments are only part of the embodiments of the present disclosure, not all of the embodiments. Based on the embodiments in the present disclosure, all other embodiments obtained by those ordinary skilled in the art without creative effort are within the scope of protection of the present disclosure.

The embodiments of the present disclosure provide a communication method, an electronic device, and a storage medium, so as to provide a way to support new links.

In the embodiments, the method and the device are based on the same application concept. Since the method and the device solve the problem in a similar principle, the implementation of the device and the method can refer to each other, and the repeated parts will be omitted.

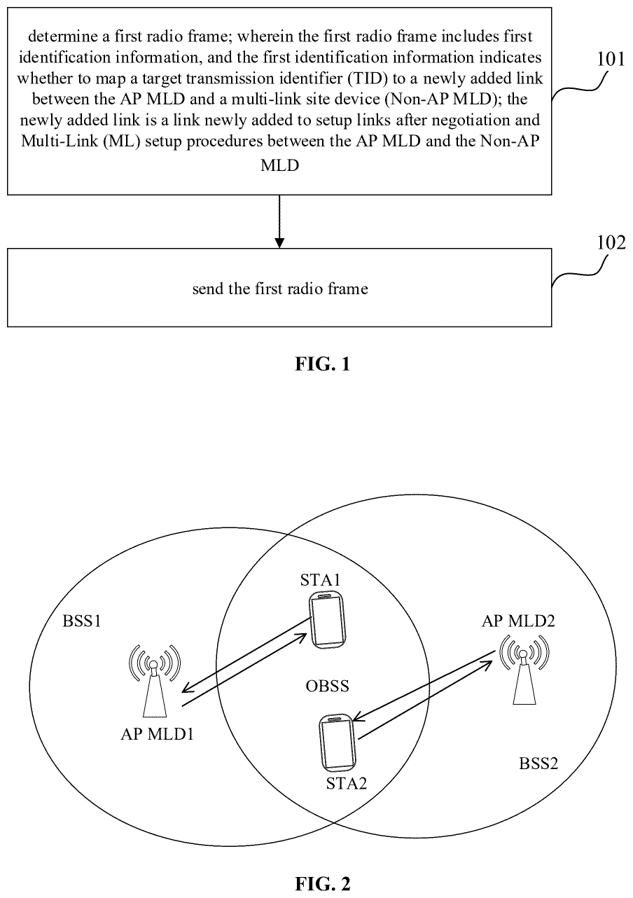

As shown in FIG. 1, an embodiment of the present disclosure provides a communication method. Optionally, the method may be applied to a multi-link access point device. Optionally, in an embodiment of the present disclosure, the multi-link access point device is, for example, a device having a wireless to wired bridging function, and the multi-link access point device is responsible for extending the services provided by the wired network to the wireless network. The multi-link site device is, for example, an electronic device having a wireless network access function, and provides a frame delivery service to enable information to be transmitted.

The method may include the following steps:
Step 101, determine a first frame; wherein the first frame includes first identification information, and the first identification information indicates whether to map a target Traffic Identifier (TID) to a newly added link between the AP MLD and a multi-link site device (Non-AP MLD); the newly added link is a link newly added to setup links after negotiation and Multi-Link (ML) setup procedures between the AP MLD and the Non-AP MLD.

In a wireless LAN, a Basic Service Set (BSS) can include an AP and one or more stations (STA) communicating with the AP. A Basic Service Set can be connected to a Distribution System (DS) through its AP, and then connected to another Basic Service Set to form an Extended Service Set (ESS). As a first example, referring to FIG. 2, AP1 and STA1 form BSS1, and AP2 and STA2 form BSS2. If the coverages of two or more BSSs overlap, an Overlapping Basic Service Set (OBSS) is formed. As shown in FIG. 2, BSS1 and BSS2 overlap to form an OBSS.

Optionally, in an embodiment of the present disclosure, the AP and STA may be devices supporting multiple links, for example, may be represented as AP MLD and Non-AP MLD respectively. The AP MLD may represent an access point supporting multiple link communication functions, and Non-AP MLD may represent a site supporting multiple link communication functions.

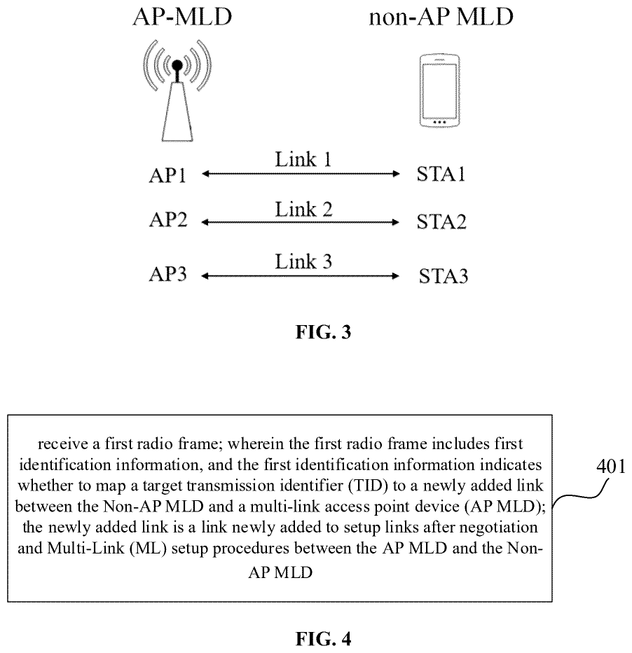

Referring to FIG. 3, the AP MLD may include three affiliated APs, such as AP1, AP2 and AP3 as shown in FIG. 3; each AP can operate in link 1, link 2 and link 3 respectively. The Non-AP MLD may also include three affiliated STAs, such as STA1, STA2 and STA3 as shown in FIG. 2; STA1 operates in link 1, STA2 operates in link 2 and STA3 operates in link 3.

For ease of description, thereinafter, the example in which an AP communicates with a STA under multiple links is mainly described, however, the example embodiments of the present disclosure are not limited thereto. In the example of FIG. 3, it is assumed that the AP1 communicates with the STA1 through the corresponding first link Link 1, similarly, the AP2 communicates with the STA2 through the corresponding second link Link 2, and the AP3 communicates with the STA3 through the third link Link 3. In addition, Link 1 to Link 3 may be multiple links at different frequencies, for example, links at 2.4 GHz, 5 GHz, and 6 GHz, or several links of the same or different bandwidths at 2.4 GHz. In addition, multiple channels may exist under each link. It is understood that the communication scenario shown in FIG. 2 is only exemplary, and the present disclosure is not limited thereto. For example, an AP MLD may be connected to multiple (three) Non-AP MLDs, or under each link, an AP may communicate with multiple other types of stations.

Typically, multiple links between a Non-AP MLD and an AP MLD are established through the exchange of (Re) Association Request frames (or Re-association Request frames) and Association Response frames (or Re-association Response frames) between the two. For example, the number of links established between the two and the basic attributes of each link are negotiated by carrying the Basic Multi-Link element in the above frames; and the basic attributes include link identifiers (Link ID), and MLD capabilities and operations.

After the multi-link is negotiated and successfully established between the Non-AP and AP ML, the AP MLD can add or delete affiliated APs to add new links or delete established links. For example, the AP MLD indicates the addition of a new affiliated AP of the AP MLD by a beacon frame or a Basic Multi-Link element of a probe response frame, and by a Reduced Neighbor Report element.

When adding new links to Non-AP MLD and AP MLD, the two need to negotiate to map services and links. Specifically, in the Traffic Identifier-to-Link mapping (TID-to-Link mapping) mechanism, before adding the affiliated AP and affiliated STA, the TID-to-Link mapping has been completed, while new affiliated APs and affiliated STAs are added to the Non-AP MLD and AP MLD, so the TID type mapped to the newly established link needs to be specified when adding a new link between the AP MLD and Non-AP MLD. In the embodiment of the present disclosure, the AP MLD determines a first frame, and the first frame carries first identification information, and indicates whether to map the target TID to the newly added link between the AP MLD and the multi-link site device (Non-AP MLD) through the first identification information; the newly added link is a newly added link to setup links after negotiation and ML setup procedures between the AP MLD and the Non-AP MLD, and the newly added link can be a newly added link caused by a newly added affiliated AP or a newly added affiliated STA.

The target TID includes all TIDs of the AP MLD, that is, the TIDs after negotiation and ML setup procedures between the AP MLD and the Non-AP MLD. After negotiation and ML setup procedures between the Non-AP MLD and the AP MLD, a new link is added, and thus the first identification information indicates whether to map the target TID to the newly added link. Optionally, the first frame includes a multi-link reconfiguration request frame (ML Reconfiguration Request frame), and the first identification information can be a field in an element in the ML Reconfiguration Request frame; for example, if the field is set to “1”, it indicates that the target TID needs to be mapped to the newly added link; if the field is set to “0”, it indicates that the TID does not need to be mapped to the newly added link.

Step 102, send the first frame.

The AP MLD sends the first frame, and after receiving the first frame, the Non-AP MLD determines, based on the first identification information, whether the AP MLD creates a TID-to-Link mapping for the link of the newly added affiliated AP; in this way, when a new link is added, there is no need for the Non-AP MLD and the AP MLD to negotiate the TID-to-Link mapping through a dedicated message, thereby reducing signaling overhead.

The embodiment of the present disclosure provides a communication method. Optionally, the method may be applied to a multi-link access point device. The method includes:
determining a first frame; wherein the first frame includes first identification information, and the first identification information indicates whether to map a target Traffic Identifier (TID) to a newly added link between the AP MLD and the multi-link site device (Non-AP MLD); the newly added link is a newly added link to setup links after negotiation and ML setup procedures between the AP MLD and the Non-AP MLD; and
sending the first frame.

In the embodiment, the first identification information is carried in a Reconfiguration Multi-Link element of the first frame.

The first identification information is carried in the station device (STA) Control field of the Reconfiguration Multi-Link element, and the Reconfiguration Multi-Link element is carried in a multi-link reconfiguration request frame (ML Reconfiguration Request frame), for example.

The first identification information is, for example, the Traffic Mapping Present bit; as a second example, the format of the STA Control field is as shown in the following Table 1.

TABLE 1

| | | | MAC | Delete | Traffic | |
|---|---|---|---|---|---|---|
| | | Complete | Address | Timer | Mapping | |
| content | Link ID | Profile | Present | Present | Present | Reserved |
| Bits | 4 | 1 | 1 | 1 | 1 | 8 |
| Bit order | B 0 to B 3 | B 4 | B 5 | B 6 | B 7 | B 8 to B 15 |

As shown in Table 1, the Traffic Mapping Present bit is added to the STA Control field; for example, if the field is set to “1”, it indicates that the target TID needs to be mapped to the newly added link; if the field is set to “0”, it indicates that the TID does not need to be mapped to the newly added link.

An embodiment of the present disclosure provides a communication method. Optionally, the method may be applied to a multi-link access point device. The method includes:
determining a first frame; wherein the first frame includes first identification information, and the first identification information indicates whether to map a target Traffic Identifier (TID) to a newly added link between the AP MLD and the multi-link site device (Non-AP MLD); the newly added link is a newly added link to setup links after negotiation and ML setup procedures between the AP MLD and the Non-AP MLD; and
sending the first frame.

In the embodiment, the first identification information is carried in a Reconfiguration Multi-Link element of the first frame.

The first identification information is carried in the station device (STA) Control field of the Reconfiguration Multi-Link element.

When the first identification information indicates to map the target TID to the newly added link, the STA information field of the Reconfiguration Multi-Link element includes second identification information; the second identification information is, for example, a Traffic mapping Bitmap subfield in the STA information field.

The second identification information indicates the TID information on the newly added link, that is, the TID information that needs to be mapped on the newly added link; as a third example, taking the Traffic mapping Bitmap subfield as an example, the format of the STA information field is shown in the following Table 2:

TABLE 2

| | STA | | | Traffic |
|---|---|---|---|---|
| Information | Info | STA MAC | Delete | mapping |
| content | Length | Address | Timer | Bitmap) |
| Byte | 1 | 0 or 6 | 0 or 2 | 0 or 1 |
| number | | | | |
| (Octets) | | | | |

As shown in Table 2, when the first identification information (Traffic mapping Present bit) in the STA Control field is 1, the Traffic mapping Bitmap subfield contains one byte, and the i-th (0≤i≤7) bit is set to 1, indicating that TID i is mapped on the newly added link in the STA Control field. For example, if the Traffic Mapping Present bit is 1 and the Traffic Mapping Bitmap subfield is 10100110, it means that TID 0, TID 2, TID5 and TID 6 need to be mapped on the newly added link respectively.

An embodiment of the present disclosure provides a communication method. Optionally, the method may be applied to a multi-link access point device. The method includes:
determining a first frame; wherein the first frame includes first identification information, and the first identification information indicates whether to map a target Traffic Identifier (TID) to a newly added link between the AP MLD and the multi-link site device (Non-AP MLD); the newly added link is a newly added link to setup links after negotiation and ML setup procedures between the AP MLD and the Non-AP MLD; and
sending the first frame.

In the embodiment, the Reconfiguration Multi-Link element indicates that after negotiation and ML setup procedures between the AP MLD and the Non-AP MLD, the AP MLD adds an affiliated AP or deletes an affiliated AP.

In the embodiment, the first frame, for example, an ML Reconfiguration Request frame, includes the Reconfiguration Multi-Link element. The Reconfiguration Multi-Link element is used to instruct the AP MLD to add a new affiliated AP or delete an original affiliated AP after establishing a Multi-link setup with the Non-AP MLD.

An embodiment of the present disclosure provides a communication method. Optionally, the method may be applied to a multi-link access point device. The method includes:
determining a first frame; wherein the first frame includes first identification information, and the first identification information indicates whether to map a target Traffic Identifier (TID) to a newly added link between the AP MLD and the multi-link site device (Non-AP MLD); the newly added link is a newly added link to setup links after negotiation and ML setup procedures between the AP MLD and the Non-AP MLD; and
sending the first frame.

In the embodiment, the first identification information is carried in a multi-link reconfiguration (Reconfiguration Multi-Link) element of the first frame.

The first identification information is carried in the station device (STA) Control field of the Reconfiguration Multi-Link element, and the Common Information field of the Reconfiguration Multi-Link element or the Common Information field of the basic multi-link (Basic Multi-Link) element sent by the AP MLD includes third identification information, and the third identification information indicates whether the AP MLD supports multi-link reconfiguration capability.

In the embodiment, the third identification information indicates whether the AP MLD supports multi-link reconfiguration capability, and can be carried in the Common Information field of the Reconfiguration Multi-Link element, or carried in the Common Information field of the basic multi-link (Basic Multi-Link) element sent by the AP MLD; as a fourth example, taking the third identification information being ML Reconfiguration Support subfield as an example, the format of the public information field is shown in Table 3 below:

TABLE 3

| | | | | Frequency | | | |
|---|---|---|---|---|---|---|---|
| | Maximum | | TID-To-Link | Separation | | | |
| | number of | | Mapping | For STR/AP | | ML | |
| | simultaneous | SRS | Negotiation | MLD Type | AAR | Reconfiguration | |
| content | links | Support | Support | Indication | Support | Support | Reserved |
| Bits | 4 | 1 | 2 | 5 | 1 | 1 | 2 |
| Bit | B 0 to | B 4 | B 5 to | B 7 to | B 12 | B 13 | B 14 to |
| order | B 3 | | B 6 | B 11 | | | B 15 |

In the embodiment, when the ML Reconfiguration Support bit is set to 1, it indicates that the AP MLD supports ML reconfiguration; when the ML Reconfiguration Support bit is set to 0, it indicates that it does not support ML reconfiguration.

An embodiment of the present disclosure provides a communication method. Optionally, the method may be applied to a multi-link access point device. The method includes:
determining a first frame; wherein the first frame includes first identification information, and the first identification information indicates whether to map a target Traffic Identifier (TID) to a newly added link between the AP MLD and the multi-link site device (Non-AP MLD); the newly added link is a newly added link to setup links after negotiation and ML setup procedures between the AP MLD and the Non-AP MLD; and
sending the first frame.

In the embodiment, the first identification information is carried in a multi-link reconfiguration (Reconfiguration Multi-Link) element of the first frame.

The first identification information is carried in the station device (STA) Control field of the Reconfiguration Multi-Link element, and the Reconfiguration Multi-Link element is carried in a multi-link reconfiguration request frame (ML Reconfiguration Request frame), for example.

The presence indication subfield of the Reconfiguration Multi-Link element includes fourth identification information, where the fourth identification information indicates whether the AP MLD supports multi-link capability and multi-link operation;
and/or
the public information field of the Reconfiguration Multi-Link element includes fifth identification information, and the fifth identification information indicates whether the AP MLD supports multi-link capability and multi-link operation.

As a fifth example, taking the fourth identification information being the MLD Capabilities and Operations Present identification bit as an example, the format of the presence indication subfield of the Reconfiguration Multi-Link element is as shown in the following Table 4:

TABLE 4

| | | MLD | |
|---|---|---|---|
| | MLD | Capabilities | |
| | MAC | and | |
| | Address | Operations | |
| content | Present | Present | Reserved |
| Bits | 1 | 1 | 10 |
| Bit order | B0 | B1 | B2 to B11 |

In the embodiment, if the MLD Capabilities and Operations Present identification bit is set to 1, it indicates that the AP MLD supports multi-link capabilities and multi-link operations; if the MLD Capabilities and Operations Present identification bit is set to 0, it indicates that the AP MLD does not support multi-link capabilities and multi-link operations.

Taking the fifth identification information being the MLD Capabilities and Operations subfield as an example, the format of the Common Information field of the Reconfiguration Multi-Link element is as shown in the following Table 5:

TABLE 5

| | | | Multi-Link |
|---|---|---|---|
| | | | Device |
| | | | Reconfiguration |
| | | | Capabilities |
| | | | (MLD |
| | Common | MLD | Capabilities |
| Information | Info | MAC | and |
| content | Length | Address | Operations) |
| Byte | 1 | 0 or 6 | 0 or 2 |
| number | | | |
| (Octets) | | | |

In the embodiment, if the MLD Capabilities and Operations Present subfield is set to 1, it indicates that the AP MLD supports multi-link capabilities and multi-link operations; if the MLD Capabilities and Operations Present subfield is set to 0, it indicates that the AP MLD does not support multi-link capabilities and multi-link operations.

An embodiment of the present disclosure provides a communication method. Optionally, the method may be applied to a multi-link access point device. The method includes:
determining a first frame; wherein the first frame includes first identification information, and the first identification information indicates whether to map a target Traffic Identifier (TID) to a newly added link between the AP MLD and the multi-link site device (Non-AP MLD); the newly added link is a newly added link to setup links after negotiation and ML setup procedures between the AP MLD and the Non-AP MLD; and
sending the first frame.

In the embodiment, the first identification information is carried in a multi-link reconfiguration (Reconfiguration Multi-Link) element of the first frame.

The first identification information is carried in the station device (STA) Control field of the Reconfiguration Multi-Link element, and the Reconfiguration Multi-Link element is carried in a multi-link reconfiguration request frame (ML Reconfiguration Request frame); the STA Control field includes a traffic mapping present indication subfield present indication bit (Traffic mapping Present).

The Traffic mapping Present indication subfield present indication bit being set to a first value, for example, the first value is 1, indicating that the link corresponding to the STA Control field is the newly added link, and TID mapping needs to be performed for the newly added link. If the Traffic mapping Present indication subfield present bit being set to 0, or the first identification information indicates that the link is a deleted link, TID mapping does not need to be performed for the link.

In an optional embodiment, the method further includes:
receiving a second frame; wherein the second frame includes sixth identification information, and the sixth identification information indicates whether to map the target Traffic Identifier (TID) to the newly added link between the AP MLD and the Non-AP MLD; the newly added link is a link newly added to setup links after negotiation and ML setup procedures between the AP MLD and the Non-AP MLD.

The second frame is, for example, a multi-link reconfiguration request frame (ML Reconfiguration Request frame); the Non-AP MLD determines the second frame, carries sixth identification information in the second frame, and indicates, through the sixth identification information, whether to map the target TID to a newly added link between the AP MLD and the Non-AP MLD; the newly added link is a link newly added to setup links after negotiation and ML setup procedures between the AP MLD and the Non-AP MLD, and the newly added link may be a newly added link caused by a newly added affiliated AP or a newly added affiliated STA.

If the Non-AP MLD indicates through the sixth identification information that the target TID needs to be mapped to the newly added link, the AP MLD maps the target TID to the newly added link.

In an optional embodiment, after receiving the second frame, the method includes:
when the AP MLD supports the multi-link reconfiguration capability, feeding back a third frame to the Non-AP MLD, where the third frame is used to respond to the second frame; optionally, the second frame includes a multi-link reconfiguration request frame (ML Reconfiguration Request frame); and the third frame includes a multi-link reconfiguration response frame (ML Reconfiguration Response frame).

In the embodiment, the information on whether the AP MLD supports the multi-link reconfiguration capability is carried in the Common Information field of the multi-link reconfiguration (Reconfiguration Multi-Link) element or the Common Information field of the basic multi-link (Basic Multi-Link) element sent by the AP MLD.

In the embodiment, when the AP MLD receiving the second frame supports ML reconfiguration, the AP MLD feeds back a third frame, such as an ML Reconfiguration Response frame; otherwise, the AP MLD may not feed back an ML Reconfiguration Response frame. And for the information on whether the multi-link reconfiguration capability is supported, it may carry an identification bit in the public information field of the Reconfiguration Multi-Link element or the public information field of the basic multi-link (Basic Multi-Link) element sent by the AP MLD, indicating whether it supports ML reconfiguration.

In an optional embodiment, the third frame includes seventh identification information, and the seventh identification information indicates whether the AP MLD successfully accepts the second frame.

The seventh identification information, for example, Status Code, may be used to indicate whether the AP MLD will accept the request in the second frame for mapping the target TID to the newly added link after receiving the second frame.

In an optional embodiment, when the seventh identification information is set to a second parameter value, and the Reconfiguration Multi-Link element of the second frame indicates that the second frame is used for a newly added link, the STA information field of the Reconfiguration Multi-Link element includes a Traffic mapping Present indication subfield, and the Traffic mapping Present indication subfield includes the transmission type of the newly added link.

In the embodiment, when the seventh identification information is set to the second parameter value, for example, when the Status Code field is set to Success, a link carried in the Reconfiguration Multi-Link element is newly created or deleted between the Non-AP MLD and the AP MLD. When the Reconfiguration Multi-Link element of the second frame indicates that the request is for a newly added link, the STA Info field includes a traffic mapping present indication subfield (Traffic mapping Bitmap), as shown in the aforementioned Table 2, and the traffic mapping present indication subfield includes the traffic type of the newly added link mapped on the added link.

In addition, when the seventh identification information is set to a third parameter value, for example, when the Status Code field is not Success, it indicates that the request to create or delete a link by the ML Reconfigurable Request frame fails, and thus no link is added or deleted.

In the embodiment of the present disclosure, the AP MLD determines a first frame; wherein the first frame includes first identification information, and the first identification information indicates whether to map the target Traffic Identifier (TID) to the newly added link between the AP MLD and the multi-link site device (Non-AP MLD); the AP MLD sends the first frame, so that after receiving the first frame, the Non-AP MLD determines whether the AP MLD creates a TID-to-Link mapping for the newly added link of the affiliated AP according to the first identification information; in this way, when adding a new link, the Non-AP MLD and the AP MLD do not need to negotiate the TID-to-Link mapping through a dedicated message, thereby reducing signaling overhead. The embodiment of the present disclosure provides a method for supporting new links to improve the MLO mechanism.

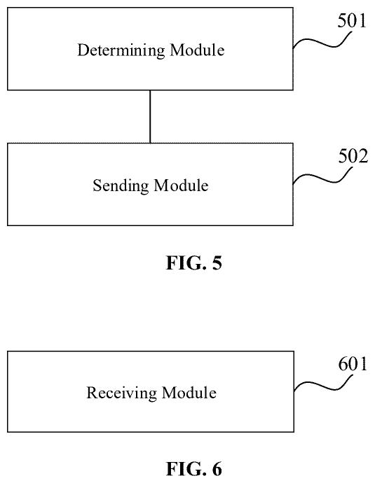

Referring to FIG. 4, an embodiment of the present disclosure provides a communication method. Optionally, the method may be applied to a multi-connected site device Non-AP MLD. The method may include the following steps:

Step 401, receive a first frame; wherein the first frame includes first identification information, and the first identification information indicates whether to map a target Traffic Identifier (TID) to a newly added link between the Non-AP MLD and a multi-link access point device (AP MLD); the newly added link is a link newly added to setup links after negotiation and ML setup procedures between the AP MLD and the Non-AP MLD.

In the embodiment, the architecture of the WLAN applied in the communication method provided in the embodiment of the present disclosure refers to the aforementioned first example and will not be described in detail here.

Typically, multiple links between a Non-AP MLD and an AP MLD are established through the exchange of (Re) Association Request frames (or Re-association Request frames) and Association Response frames (or Re-association Response frames) between the two. For example, the number of links established between the two and the basic attributes of each link are negotiated by carrying the Basic Multi-Link element in the above frames; and the basic attributes include link identifiers (Link ID), and MLD capabilities and operations. In addition, MLO also provides traffic-to-link mapping to further refine the attributes of each link and the characteristics of communication services, and realize load balancing and power saving mechanisms between links. For example, the R-TWT mechanism can improve transmission efficiency and reduce device power consumption by identifying low-latency services and giving priority to the transmission of low-latency services.

After the multi-link is negotiated and successfully established between the Non-AP and AP ML, the AP MLD can add or delete affiliated APs to add new links or delete established links. For example, the AP MLD indicates the addition of a new affiliated AP of the AP MLD by a beacon frame or a Basic Multi-Link element of a probe response frame, and by a Reduced Neighbor Report element.

When adding new links to Non-AP MLD and AP MLD, the two need to negotiate to map services and links. Specifically, in the Traffic Identifier-to-Link mapping (TID-to-Link mapping) mechanism, before adding the affiliated AP and affiliated STA, the TID-to-Link mapping has been completed, while new affiliated APs and affiliated STAs are added to the Non-AP MLD and AP MLD, so the TID type mapped to the newly established link needs to be specified when adding a new link between the AP MLD and Non-AP MLD, and therefore the TID is needed to be mapped to the newly added link. In the embodiment of the present disclosure, the AP MLD carries first identification information in the first frame, and indicates whether to map the target TID to the newly added link between the AP MLD and the multi-link site device (Non-AP MLD) through the first identification information; the newly added link is a newly added link to setup links after negotiation and ML setup procedures between the AP MLD and the Non-AP MLD, and the newly added link can be a newly added link caused by a newly added affiliated AP or a newly added affiliated STA.

The target TID includes all TIDs of the AP MLD, that is, the TIDs after negotiation and ML setup procedures between the AP MLD and the Non-AP MLD. After negotiation and ML setup procedures between the AP MLD and the Non-AP MLD, a new link is added, and thus the first identification information indicates whether to map the target TID to the newly added link. Optionally, the first frame includes a multi-link reconfiguration request frame (ML Reconfiguration Request frame), and the first identification information can be a field in an element in the ML Reconfiguration Request frame; for example, if the field is set to “1”, it indicates that the target TID needs to be mapped to the newly added link; if the field is set to “0”, it indicates that the TID does not need to be mapped to the newly added link.

After receiving the first frame, the Non-AP MLD determines, based on the first identification information, whether the AP MLD creates a TID-to-Link mapping for the newly added link of the affiliated AP; in this way, when a new link is added, the Non-AP MLD and the AP MLD do not need to negotiate the TID-to-Link mapping through a dedicated message, thereby reducing signaling overhead.

The embodiment of the present disclosure provides a communication method. Optionally, the method may be applied to a multi-link site device (Non-AP MLD). The method may include the following steps:
receiving a first frame; wherein the first frame includes first identification information, and the first identification information indicates whether to map a target Traffic Identifier (TID) to a newly added link between the Non-AP MLD and a multi-link access point device (AP MLD); the newly added link is a link newly added to setup links after negotiation and ML setup procedures between the AP MLD and the Non-AP MLD.

When the Non-AP MLD supports the multi-link reconfiguration capability, a fourth frame is fed back to the AP MLD, where the fourth frame is used to respond to the first frame; optionally, the first frame includes a multi-link reconfiguration request frame (ML Reconfiguration Request frame); and the fourth frame includes a multi-link reconfiguration response frame (ML Reconfiguration Response frame).

In the embodiment, the information on whether the Non-AP MLD supports the multi-link reconfiguration capability is carried in the Common Information field of the multi-link reconfiguration (Reconfiguration Multi-Link) element or the Common Information field of the basic multi-link (Basic Multi-Link) element sent by the Non-AP MLD.

In the embodiment, when the AP MLD receiving the first frame supports ML reconfiguration, the Non-AP MLD feeds back a fourth frame, such as an ML Reconfiguration Response frame; otherwise, the Non-AP MLD may not feed back an ML Reconfiguration Response frame. And for the information on whether the multi-link reconfiguration capability is supported, it may carry an identification bit in the public information field of the Reconfiguration Multi-Link element or the public information field of the basic multi-link (Basic Multi-Link) element sent by the Non-AP MLD, indicating whether it supports ML reconfiguration.

The embodiment of the present disclosure provides a communication method. Optionally, the method may be applied to a multi-link site device (Non-AP MLD). The method may include the following steps:
receiving a first frame; wherein the first frame includes first identification information, and the first identification information indicates whether to map a target Traffic Identifier (TID) to a newly added link between the Non-AP MLD and a multi-link access point device (AP MLD); the newly added link is a link newly added to setup links after negotiation and ML setup procedures between the AP MLD and the Non-AP MLD.

When the Non-AP MLD supports the multi-link reconfiguration capability, a fourth frame is fed back to the AP MLD, where the fourth frame is used to respond to the first frame.

In the embodiment, the information on whether the Non-AP MLD supports the multi-link reconfiguration capability is carried in the Common Information field of the multi-link reconfiguration (Reconfiguration Multi-Link) element or the Common Information field of the basic multi-link (Basic Multi-Link) element sent by the Non-AP MLD.

The fourth frame includes eighth identification information, and the eighth identification information indicates whether the Non-AP MLD successfully accepts the first frame.

In the embodiment, the eighth identification information, for example, Status Code, may be used to indicate whether the Non-AP MLD will accept the request in the first frame for mapping the target TID to the newly added link after receiving the first frame.

In an optional embodiment, when the eighth identification information is set to a fourth parameter value, and the Reconfiguration Multi-Link element of the first frame indicates that the first frame is used for a newly added link, the STA information field of the Reconfiguration Multi-Link element includes a Traffic mapping Present indication subfield, and the Traffic mapping Present indication subfield includes the transmission type of the newly added link.

In the embodiment, when the eighth identification information is set to the fourth parameter value, for example, when the Status Code field is set to Success, a link carried in the Reconfiguration Multi-Link element is newly created or deleted between the Non-AP MLD and the AP MLD. When the Reconfiguration Multi-Link element of the first frame indicates that the request is for a newly added link, the STA Info field includes a traffic mapping present indication subfield (Traffic mapping Bitmap), as shown in the aforementioned Table 2, and the traffic mapping present indication subfield includes the traffic type of the newly added link mapped on the added link.

In addition, when the eighth identification information is set to a third parameter value, for example, when the Status Code field is not Success, it indicates that the request to create or delete a link by the ML Reconfigurable Request frame fails, and thus no link is added or deleted.

The embodiment of the present disclosure provides a communication method. Optionally, the method may be applied to a multi-link site device (Non-AP MLD). The method may include the following steps:
receiving a first frame; wherein the first frame includes first identification information, and the first identification information indicates whether to map a target Traffic Identifier (TID) to a newly added link between the Non-AP MLD and a multi-link access point device (AP MLD); the newly added link is a link newly added to setup links after negotiation and ML setup procedures between the AP MLD and the Non-AP MLD.

The first identification information is carried in a Reconfiguration Multi-Link element of the first frame.

The first identification information is carried in the station device (STA) Control field of the Reconfiguration Multi-Link element, and the Reconfiguration Multi-Link element is carried in a multi-link reconfiguration request frame (ML Reconfiguration Request frame). The first identification information is, for example, a Traffic Mapping Present bit, and the format of the STA Control field is as shown in the aforementioned Table 1, and the Traffic Mapping Present bit is added to the STA Control field; for example, if the field is set to “1”, it indicates that the target TID needs to be mapped to the newly added link; if the field is set to “0”, it indicates that the TID does not need to be mapped to the newly added link.

The embodiment of the present disclosure provides a communication method. Optionally, the method may be applied to a multi-link site device (Non-AP MLD). The method may include the following steps:
receiving a first frame; wherein the first frame includes first identification information, and the first identification information indicates whether to map a target Traffic Identifier (TID) to a newly added link between the Non-AP MLD and a multi-link access point device (AP MLD); the newly added link is a link newly added to setup links after negotiation and ML setup procedures between the AP MLD and the Non-AP MLD.

The first identification information is carried in a Reconfiguration Multi-Link element of the first frame.

The first identification information is carried in the station device (STA) Control field of the Reconfiguration Multi-Link element.

When the first identification information indicates to map the target TID to the newly added link, the STA information field of the Reconfiguration Multi-Link element includes second identification information.

The second identification information indicates TID information on the newly added link.

The second identification information indicates the TID information on the newly added link, that is, the TID information that needs to be mapped on the newly added link; taking the Traffic mapping Bitmap subfield as an example, the format of the STA information field is as shown in the aforementioned Table 2. When the first identification information (Traffic mapping Present bit) in the STA Control field is 1, the Traffic mapping Bitmap subfield contains one byte, and the i-th (0≤i≤7) bit is set to 1, indicating that TID i is mapped on the newly added link in the STA Control field. For example, if the Traffic Mapping Present bit is 1 and the Traffic Mapping Bitmap subfield is 10100110, it means that TID 0, TID 2, TID5 and TID 6 need to be mapped on the newly added link respectively.

The embodiment of the present disclosure provides a communication method. Optionally, the method may be applied to a multi-link site device (Non-AP MLD). The method may include the following steps:
receiving a first frame; wherein the first frame includes first identification information, and the first identification information indicates whether to map a target Traffic Identifier (TID) to a newly added link between the Non-AP MLD and a multi-link access point device (AP MLD); the newly added link is a link newly added to setup links after negotiation and ML setup procedures between the AP MLD and the Non-AP MLD.

The first identification information is carried in a Reconfiguration Multi-Link element of the first frame.

The first identification information is carried in the station device (STA) Control field of the Reconfiguration Multi-Link element.

The Reconfiguration Multi-Link element indicates that after negotiation and ML setup procedures between the AP MLD and the Non-AP MLD, the AP MLD adds an affiliated AP or deletes an affiliated AP.

In the embodiment, the first frame, for example, an ML Reconfiguration Request frame, includes a Reconfiguration Multi-Link element. The Reconfiguration Multi-Link element is used to instruct the AP MLD to add a new affiliated AP or delete an original affiliated AP after establishing a Multi-link setup with the Non-AP MLD.

The embodiment of the present disclosure provides a communication method. Optionally, the method may be applied to a multi-link site device (Non-AP MLD). The method may include the following steps:
receiving a first frame; wherein the first frame includes first identification information, and the first identification information indicates whether to map a target Traffic Identifier (TID) to a newly added link between the Non-AP MLD and a multi-link access point device (AP MLD); the newly added link is a link newly added to setup links after negotiation and ML setup procedures between the AP MLD and the Non-AP MLD.

The first identification information is carried in a Reconfiguration Multi-Link element of the first frame.

The first identification information is carried in the station device (STA) Control field of the Reconfiguration Multi-Link element.

The Common Information field of the Reconfiguration Multi-Link element or the Common Information field of the Basic Multi-Link element element sent by the AP MLD includes third identification information, and the third identification information indicates whether the AP MLD supports multi-link reconfiguration capability.

In the embodiment, the third identification information indicates whether the AP MLD supports multi-link reconfiguration capability, and can be carried in the Common Information field of the Reconfiguration Multi-Link element, or carried in the Common Information field of the basic multi-link (Basic Multi-Link) element sent by the AP MLD. Taking the third identification information being ML Reconfiguration Support subfield as an example, the format of the public information field is shown in Table 3 above, where when the ML Reconfiguration Support bit is set to 1, it indicates that the AP MLD supports ML reconfiguration; when the ML Reconfiguration Support bit is set to 0, it indicates that it does not support ML reconfiguration.

The embodiment of the present disclosure provides a communication method. Optionally, the method may be applied to a multi-link site device (Non-AP MLD). The method may include the following steps:
receiving a first frame; wherein the first frame includes first identification information, and the first identification information indicates whether to map a target Traffic Identifier (TID) to a newly added link between the Non-AP MLD and a multi-link access point device (AP MLD); the newly added link is a link newly added to setup links after negotiation and ML setup procedures between the AP MLD and the Non-AP MLD.

The first identification information is carried in a Reconfiguration Multi-Link element of the first frame.

The first identification information is carried in the station device (STA) Control field of the Reconfiguration Multi-Link element.

The presence indication subfield of the Reconfiguration Multi-Link element includes fourth identification information, where the fourth identification information indicates whether the AP MLD supports multi-link capability and multi-link operation;
and/or
the public information field of the Reconfiguration Multi-Link element includes fifth identification information, and the fifth identification information indicates whether the AP MLD supports multi-link capability and multi-link operation.

In the embodiment, taking the fourth identification information being the MLD Capabilities and Operations Present identification bit as an example, the format of the present indication subfield of the Reconfiguration Multi-Link element is as shown in the aforementioned Table 4. If the MLD Capabilities and Operations Present identification bit is set to 1, it indicates that the AP MLD supports multi-link capabilities and multi-link operations; if the MLD Capabilities and Operations Present identification bit is set to 0, it indicates that the AP MLD does not support multi-link capabilities and multi-link operations.

The format of the Common Information field of the Reconfiguration Multi-Link element is as shown in Table 5 above. If the MLD Capabilities and Operations Present subfield is set to 1, it indicates that the AP MLD supports multi-link capabilities and multi-link operations; if the MLD Capabilities and Operations Present subfield is set to 0, it indicates that the AP MLD does not support multi-link capabilities and multi-link operations.

The embodiment of the present disclosure provides a communication method. Optionally, the method may be applied to a multi-link site device (Non-AP MLD). The method may include the following steps:
receiving a first frame; wherein the first frame includes first identification information, and the first identification information indicates whether to map a target Traffic Identifier (TID) to a newly added link between the Non-AP MLD and a multi-link access point device (AP MLD); the newly added link is a link newly added to setup links after negotiation and ML setup procedures between the AP MLD and the Non-AP MLD.

The first identification information is carried in a Reconfiguration Multi-Link element of the first frame.

The first identification information is carried in the station device (STA) Control field of the Reconfiguration Multi-Link element.

The STA Control field includes a Traffic mapping Present indication subfield present indication bit.

The Traffic mapping Present indication subfield present indication bit being set to a first value, for example, the first value is 1, indicating that the link corresponding to the STA Control field is the newly added link, and TID mapping needs to be performed for the newly added link. If the Traffic mapping Present indication subfield present indication bit being set to 0, or the first identification information indicates that the link is a deleted link, TID mapping does not need to be performed for the link.

In an optional embodiment, the method further includes:
determining a second frame; wherein the second frame includes sixth identification information, and the sixth identification information indicates whether to map the target Traffic Identifier (TID) to a newly added link between the AP MLD and the Non-AP MLD; the newly added link is a link newly added to setup links after negotiation and ML setup procedures between the AP MLD and the Non-AP MLD; and
sending the second frame.

In the embodiment, the second frame is, for example, a multi-link reconfiguration request frame (ML Reconfiguration Request frame); the Non-AP MLD determines the second frame, carries sixth identification information in the second frame, and indicates, through the sixth identification information, whether to map the target TID to a newly added link between the AP MLD and the Non-AP MLD; the newly added link is a newly added link to setup links after negotiation and ML setup procedures between the AP MLD and the Non-AP MLD, and the newly added link may be a newly added link caused by a newly added affiliated AP or a newly added affiliated STA.

If the Non-AP MLD indicates through the sixth identification information that the target TID needs to be mapped to the newly added link, the AP MLD maps the target TID to the newly added link.

In the embodiment of the present disclosure, the Non-AP MLD receives the first frame, and determines whether the AP MLD creates a TID-to-Link mapping for the link of the newly added affiliated AP according to the first identification information; in this way, when a new link is added, the Non-AP MLD and the AP MLD do not need to negotiate the TID-to-Link mapping through a dedicated message, thereby reducing signaling overhead. The embodiment of the present disclosure provides a method for supporting new links to improve the MLO mechanism.

Referring to FIG. 5, based on the same principle as the method provided in the embodiment of the present disclosure, the embodiment of the present disclosure further provides an electronic device, the electronic device is a multi-link access point device (AP MLD), and the electronic device includes:
a determining module 501, configured to determine a first frame; wherein the first frame includes first identification information, and the first identification information indicates whether to map a target Traffic Identifier (TID) to a newly added link between the AP MLD and a multi-link site device (Non-AP MLD); the newly added link is a link newly added to setup links after negotiation and ML setup procedures between the AP MLD and the Non-AP MLD; and
a sending module 502, configured to send the first frame.

Optionally, in an embodiment of the present disclosure, the first identification information is carried in a multi-link reconfiguration (Reconfiguration Multi-Link) element of the first frame.

The first identification information is carried in the station device (STA) Control field of the Reconfiguration Multi-Link element.

Optionally, in the embodiment of the present disclosure, when the first identification information indicates to map the target TID to the newly added link, the STA information field of the Reconfiguration Multi-Link element includes second identification information.

The second identification information indicates the TID information on the newly added link.

Optionally, in the embodiment of the present disclosure, the Reconfiguration Multi-Link element indicates that after negotiation and ML setup procedures between the AP MLD and the Non-AP MLD, the AP MLD adds an affiliated AP or deletes an affiliated AP.

Optionally, in an embodiment of the present disclosure, the Common Information field of the Reconfiguration Multi-Link element or the Common Information field of the Basic Multi-Link element sent by the AP MLD includes third identification information, and the third identification information indicates whether the AP MLD supports multi-link reconfiguration capability.

Optionally, in the embodiment of the present disclosure, the presence indication subfield of the Reconfiguration Multi-Link element includes fourth identification information, and the fourth identification information indicates whether the AP MLD supports multi-link capability and multi-link operation;
and/or
the public information field of the Reconfiguration Multi-Link element includes fifth identification information, and the fifth identification information indicates whether the AP MLD supports multi-link capability and multi-link operation.

Optionally, in an embodiment of the present disclosure, the STA Control field includes a Traffic mapping Present indication subfield present indication bit.

The Traffic mapping Present indication subfield present indication bit being set to a first value, indicating that the link corresponding to the STA Control field is the newly added link.

Optionally, in an embodiment of the present disclosure, the first frame includes a multi-link reconfiguration request frame.

Optionally, in the embodiment of the present disclosure, the electronic device further includes:
a second receiving module, configured to receive a second frame; wherein the second frame includes sixth identification information, and the sixth identification information indicates whether to map the target Traffic Identifier (TID) to a newly added link between the AP MLD and the Non-AP MLD; the newly added link is a link newly added to setup links after negotiation and ML setup procedures between the AP MLD and the Non-AP MLD.

Optionally, in the embodiment of the present disclosure, the electronic device further includes:
a first feedback module, configured to feed back a third frame to the Non-AP MLD when the AP MLD supports a multi-link reconfiguration capability, wherein the third frame is used to respond to the second frame;
wherein the information on whether the AP MLD supports the multi-link reconfiguration capability is carried in the Common Information field of the multi-link reconfiguration (Reconfiguration Multi-Link) element or the Common Information field of the basic multi-link (Basic Multi-Link) element sent by the AP MLD.

Optionally, in an embodiment of the present disclosure, the third frame includes seventh identification information, and the seventh identification information indicates whether the AP MLD successfully accepts the second frame.

Optionally, in an embodiment of the present disclosure, when the seventh identification information is set to the second parameter value, and the Reconfiguration Multi-Link element of the first frame indicates that the first frame is used for a newly added link, the STA information field of the Reconfiguration Multi-Link element includes a Traffic mapping Present indication subfield, and the Traffic mapping Present indication subfield includes the transmission type of the newly added link.

Optionally, in the embodiment of the present disclosure, the second frame includes a multi-link reconfiguration request frame.

The third frame includes a multiple link reconfiguration response frame.

The embodiment of the present disclosure further provides a communication device, which is applied to a multi-link access point device (AP MLD), and the device includes:
a frame determination module, configured to determine a first frame; wherein the first frame includes first identification information, and the first identification information indicates whether to map a target Traffic Identifier (TID) to a newly added link between the AP MLD and a multi-link site device (Non-AP MLD); the newly added link is a link newly added to setup links after negotiation and ML setup procedures between the AP MLD and the Non-AP MLD; and
a frame sending module, configured to send the first frame.

The device also includes other modules of the electronic device in the aforementioned embodiment, which will not be described in detail here.

Referring to FIG. 6, based on the same principle as the method provided in the embodiment of the present disclosure, the embodiment of the present disclosure further provides an electronic device, the electronic device is a multi-link site device (Non-AP MLD), and the electronic device includes:
a receiving module 601, configured to receive a first frame; wherein the first frame includes first identification information, and the first identification information indicates whether to map the target Traffic Identifier (TID) to the newly added link between the Non-AP MLD and a multi-link access point device (AP MLD); the newly added link is a link newly added to setup links after negotiation and ML setup procedures between the AP MLD and the Non-AP MLD.

Optionally, in an embodiment of the present disclosure, the electronic device includes:
a second feedback module, configured to feed back a fourth frame to the AP MLD when the Non-AP MLD supports a multi-link reconfiguration capability, wherein the fourth frame is used to respond to the first frame.

In the embodiment, the information on whether the Non-AP MLD supports the multi-link reconfiguration capability is carried in the Common Information field of the multi-link reconfiguration (Reconfiguration Multi-Link) element or the Common Information field of the Basic Multi-Link element sent by the Non-AP MLD.

Optionally, in the embodiment of the present disclosure, the fourth frame includes eighth identification information, and the eighth identification information indicates whether the Non-AP MLD successfully accepts the first frame.

Optionally, in an embodiment of the present disclosure, when the eighth identification information is set to the fourth parameter value, and the Reconfiguration Multi-Link element of the first frame indicates that the first frame is used for a newly added link, the STA information field of the Reconfiguration Multi-Link element includes a Traffic mapping Present indication subfield, and the Traffic mapping Present indication subfield includes the transmission type of the newly added link.

Optionally, in the embodiment of the present disclosure, the first frame includes a multi-link reconfiguration request frame.

The fourth frame includes a multiple link reconfiguration response frame.

Optionally, in an embodiment of the present disclosure, the first identification information is carried in a Reconfiguration Multi-Link element of the first frame.

The first identification information is carried in the station device (STA) Control field of the Reconfiguration Multi-Link element.

Optionally, in the embodiment of the present disclosure, when the first identification information indicates to map the target TID to the newly added link, the STA information field of the Reconfiguration Multi-Link element includes second identification information.

The second identification information indicates TID information on the newly added link.

Optionally, in the embodiment of the present disclosure, the Reconfiguration Multi-Link element indicates that after negotiation and ML setup procedures between the AP MLD and the Non-AP MLD, the AP MLD adds a new affiliated AP or deletes an affiliated AP.

Optionally, in an embodiment of the present disclosure, the Common Information field of the Reconfiguration Multi-Link element or the Common Information field of the Basic Multi-Link element element sent by the AP MLD includes third identification information, and the third identification information indicates whether the AP MLD supports multi-link reconfiguration capability.

Optionally, in the embodiment of the present disclosure, the presence indication subfield of the Reconfiguration Multi-Link element includes fourth identification information, and the fourth identification information indicates whether the AP MLD supports multi-link capability and multi-link operation;
and/or
the public information field of the Reconfiguration Multi-Link element includes fifth identification information, and the fifth identification information indicates whether the AP MLD supports multi-link capability and multi-link operation.

Optionally, in an embodiment of the present disclosure, the STA Control field includes a Traffic mapping Present indication subfield present indication bit.

The Traffic mapping Present indication subfield present indication bit being set to a first value, indicating that the link corresponding to the STA Control field is the newly added link.

Optionally, in an embodiment of the present disclosure, the first frame includes a multi-link reconfiguration request frame.

Optionally, in the embodiment of the present disclosure, the electronic device further includes:
a determining module configured to determine a second frame; wherein the second frame includes sixth identification information, and the sixth identification information indicates whether to map the target Traffic Identifier (TID) to a newly added link between the AP MLD and the Non-AP MLD; the newly added link is a link newly added to setup links after negotiation and ML setup procedures between the AP MLD and the Non-AP MLD; and
a sending module configured to send the second frame.

The present disclosure also provides a communication device, which is applied to a multi-link site device (Non-AP MLD), and the device includes:
a frame receiving module, configured to receive a first frame; wherein the first frame includes first identification information, and the first identification information indicates whether to map a target Traffic Identifier (TID) to a newly added link between the Non-AP MLD and a multi-link access point device (AP MLD); the newly added link is a link newly added to setup links after negotiation and ML setup procedures between the AP MLD and the Non-AP MLD.

The device also includes other modules of the electronic device in the above-mentioned embodiment, which will not be described in detail here.

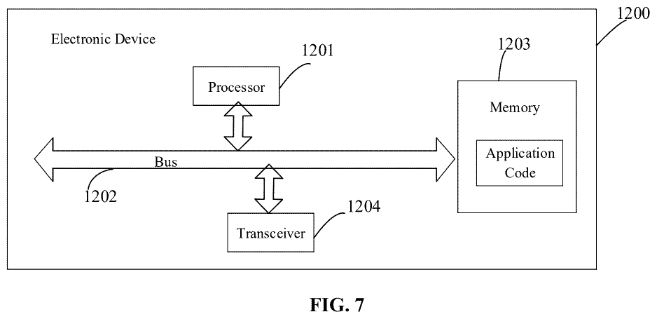

In an optional embodiment, the embodiment of the present disclosure further provides an electronic device, as shown in FIG. 7, the electronic device 700 shown in FIG. 7 may be a server, including: a processor 701 and a memory 703. The processor 701 and the memory 703 are connected, e.g., through a bus 702. Optionally, the electronic device 700 may further include a transceiver 704. It should be noted that in actual applications, the transceiver 704 is not limited to one, and the structure of the electronic device 700 does not constitute a limitation on the embodiment of the present disclosure.

The processor 701 may be a CPU (Central Processing Unit), a general-purpose processor, a DSP (Digital Signal Processor), an ASIC (Application Specific Integrated Circuit), an FPGA (Field Programmable Gate Array) or other programmable logic devices, transistor logic devices, hardware components or any combination thereof. It may implement or execute various exemplary logic blocks, modules and circuits described in conjunction with the disclosure of the present invention. The processor 701 may also be a combination that implements computing functions, such as a combination of one or more microprocessors, a combination of a DSP and a microprocessor, or the like.

The bus 702 may include a path for transmitting information between the above components. The bus 702 may be a PCI (Peripheral Component Interconnect) bus or an EISA (Extended Industry Standard Architecture) bus, or the like. The bus 702 may be divided into an address bus, a data bus, a control bus, and the like. For ease of representation, FIG. 7 only uses one thick line, but does not mean that there is only one bus or one type of bus.

The memory 703 may be a ROM (Read Only Memory) or other types of static storage devices that can store static information and instructions, a RAM (Random Access Memory) or other types of dynamic storage devices that can store information and instructions, or an EEPROM (Electrically Erasable Programmable Read Only Memory), a CD-ROM (Compact Disc Read Only Memory) or other optical disk storage, optical disk storage (including compressed optical disk, laser disk, optical disk, digital versatile disk, Blu-ray disk, or the like), a magnetic disk storage medium or other magnetic storage device, or any other medium that can be used to carry or store the desired program code in the form of instructions or data structures and can be accessed by a computer, but is not limited thereto.

The memory 703 is used to store application code for executing the solution of the present disclosure, and the execution is controlled by the processor 701. The processor 701 is used to execute the application code stored in the memory 703 to implement the content shown in the above method embodiment.

The electronic devices include, but are not limited to, mobile phones, laptop computers, digital broadcast receivers, PDAs (personal digital assistants), PADs (tablet computers), PMPs (portable multimedia players), vehicle-mounted terminals (such as vehicle-mounted navigation terminals), or the like, and fixed terminals such as digital TVs, desktop computers, etc. The electronic device shown in FIG. 7 is only an example and should not impose any limitation on the functions and scope of application of the embodiments of the present disclosure.

The embodiment of the present disclosure may be an independent physical server, or a server cluster or distributed system including multiple physical servers, or a cloud server that provides basic cloud computing services such as cloud services, cloud databases, cloud computing, cloud functions, cloud storage, network services, cloud communications, middleware services, domain name services, security services, CDN, and big data and artificial intelligence platforms. The terminal may be a smart phone, tablet computer, laptop computer, desktop computer, smart speaker, smart watch, or the like, but is not limited thereto. The terminal and the server may be directly or indirectly connected via wired or wireless communication, which is not limited by the present disclosure.

An embodiment of the present disclosure provides a computer-readable storage medium, on which a computer program is stored. When the computer-readable storage medium is run on a computer, the computer can execute the corresponding contents of the aforementioned method embodiment.

It should be understood that, although the steps in the flowchart of the accompanying drawings are displayed in sequence as indicated by the arrows, these steps are not necessarily executed in sequence in the order indicated by the arrows. Unless otherwise specified herein, there is no strict order restriction on the execution of these steps, and they can be executed in other orders. Moreover, at least a part of the steps in the flowchart of the accompanying drawings may include multiple sub-steps or multiple stages, and these sub-steps or stages are not necessarily executed at the same time, but can be executed at different times, and their execution order is not necessarily sequential, but can be executed in turn or alternately with other steps or at least a part of the sub-steps or stages of other steps.

It should be noted that the computer-readable medium mentioned above in the present disclosure may be a computer-readable signal medium or a computer-readable storage medium or any combination of the above two. The computer-readable storage medium may be, for example, but not limited to, an electrical, magnetic, optical, electromagnetic, infrared, or semiconductor system, apparatus or device, or any combination of the above. More specific examples of computer-readable storage media may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium may be any tangible medium containing or storing a program that can be used by or in combination with an instruction execution system, apparatus or device. In the present disclosure, a computer-readable signal medium may include a data signal propagated in a baseband or as part of a carrier wave, which carries a computer-readable program code. This propagated data signal may take a variety of forms, including but not limited to electromagnetic signals, optical signals, or any suitable combination of the above. The computer readable signal media may also be any computer readable medium other than computer readable storage media, which may send, propagate or transmit a program for use by or in conjunction with an instruction execution system, apparatus or device. The program code contained on the computer readable medium may be transmitted using any appropriate medium, including but not limited to: wires, optical cables, RF (radio frequency), etc., or any suitable combination of the above.

The computer-readable medium may be included in the electronic device, or may exist independently without being installed in the electronic device.

The computer-readable medium carries one or more programs. When the one or more programs are executed by the electronic device, the electronic device executes the method shown in the above embodiment.

According to one aspect of the present disclosure, a computer program product or a computer program is provided, the computer program product or the computer program comprising computer instructions, the computer instructions being stored in a computer-readable storage medium. A processor of a computer device reads the computer instructions from the computer-readable storage medium, and the processor executes the computer instructions, so that the computer device executes the methods provided in the above-mentioned various optional implementations.

The computer program code for carrying out operations of the embodiment of the present disclosure may be written in one or more programming languages or a combination thereof, including object-oriented programming languages such as Java, Smalltalk, C++, and conventional procedural programming languages such as “C” or similar programming languages. The program code may be executed entirely on the user's computer, partially on the user's computer, as a separate software package, partially on the user's computer and partially on a remote computer, or entirely on a remote computer or server. In cases involving a remote computer, the remote computer may be connected to the user's computer through any type of network, including a local area network (LAN) or a wide area network (WAN), or may be connected to an external computer (e.g., via the Internet using an Internet service provider).

The flow chart and block diagram in the accompanying drawings illustrate the possible architecture, function and operation of the system, method and computer program product according to various embodiments of the present disclosure. In this regard, each block in the flow chart or block diagram can represent a module, a program segment or a part of a code, and the module, the program segment or a part of the code contains one or more executable instructions for realizing the specified logical function. It should also be noted that in some implementations as alternatives, the functions marked in the block can also occur in a sequence different from that marked in the accompanying drawings. For example, two blocks represented in succession can actually be executed substantially in parallel, and they can sometimes be executed in the opposite order, depending on the functions involved. It should also be noted that each block in the block diagram and/or flow chart, and the combination of the blocks in the block diagram and/or flow chart can be implemented with a dedicated hardware-based system that performs a specified function or operation, or can be implemented with a combination of dedicated hardware and computer instructions.

The modules involved in the embodiments described in the present disclosure may be implemented by software or hardware. The name of a module does not limit the module itself in some cases. For example, module A may also be described as “module A for performing operation B”.

The above description is only a preferred embodiment of the present disclosure and an explanation of the technical principles used. Those skilled in the art should understand that the scope of disclosure involved in the present disclosure is not limited to the technical solutions formed by a specific combination of the above technical features, but should also cover other technical solutions formed by any combination of the above technical features or their equivalent features without departing from the above disclosed concept. For example, a technical solution formed by replacing the above features with technical features with similar functions disclosed in this disclosure (but not limited thereto).

1. A communication method, comprising:
determining, by a first multi-link device (MLD), a first frame, wherein the first frame comprises first identification information indicating whether to map a target Traffic Identifier (TID) to a newly added link between the first MLD and a second multi-link device (MLD), wherein the newly added link is a link newly added to setup links after negotiation and Multi-Link (ML) setup procedures between the first MLD and the second MLD; and
sending, by the first MLD, the first frame.

2. The communication method according to claim 1, wherein the first identification information is carried in a multi-link reconfiguration (Reconfiguration Multi-Link) element of the first frame; and
the first identification information is carried in the station device (STA) Control field of the Reconfiguration Multi-Link element.

3. The communication method according to claim 2, when the first identification information indicating that the target TID is mapped to the newly added link, an STA information field of the Reconfiguration Multi-Link element comprises second identification information; and
the second identification information indicates TID information on the newly added link.

4. The communication method according to claim 2, wherein the Reconfiguration Multi-Link element indicates that after negotiation and ML setup procedures between the first MLD and the second MLD, the first MLD adds an affiliated STA to the setup links or deletes an affiliated STA from the setup links.

5. (canceled)

6. The communication method according to claim 2, wherein a Common Information field of the Reconfiguration Multi-Link element or a Common Information field of a basic multi-link (Basic Multi-Link) element sent by the first MLD comprises third identification information, and the third identification information indicates whether the first MLD supports multi-link reconfiguration capability.

7. The communication method according to claim 2, wherein the STA Control field comprises an indication subfield; and
the indication subfield being set to a first value, indicating that the link corresponding to the STA Control field is the link added to the setup links.

8. (canceled)

9. The communication method according to claim 1, wherein the method further comprises:
receiving, by the first MILD, a second frame, wherein the second frame comprises sixth identification information, and the sixth identification information indicates whether to map the target Traffic Identifier (TID) to the newly added link between the first MLD and the second MLD, wherein the newly added link is a link newly added to setup links after negotiation and ML setup procedures between the first MLD and the second MLD.

10. The communication method according to claim 9, wherein after receiving the second frame, the method further comprises:
when the first MLD supports a multi-link reconfiguration capability, feeding back a third frame to the second MLD, wherein the third frame is used to respond to the second frame; and
wherein information indicating whether the first MLD supports the multi-link reconfiguration capability is carried in a Common Information field of the multi-link reconfiguration (Reconfiguration Multi-Link) element or a Common Information field of a basic multi-link (Basic Multi-Link) element sent by the first MLD.

11. The communication method according to claim 10, wherein the third frame comprises seventh identification information, and the seventh identification information indicates whether the first MLD successfully accepts the TID mapping indicated in the second frame.

12. The communication method according to claim 11, wherein when the seventh identification information is set to the second parameter value, and the Reconfiguration Multi-Link element of the first frame indicates that the first frame is used for a newly added link, an STA information field of the Reconfiguration Multi-Link element comprises an indication subfield, and the indication subfield comprises a transmission type of added link.

13. (canceled)

14. A communication method, comprising:
receiving, by a second multi-link device (MLD), a first frame, wherein the first frame comprises first identification information, and the first identification information indicates whether to map a target Traffic Identifier (TID) to a newly added link between the second MLD and a first multi-link device (MLD), wherein the newly added link is a link newly added to setup links after negotiation and ML setup procedures between the first MLD and the second MLD.

15. The communication method according to claim 14, wherein after receiving the first frame, the method further comprises:
when the second MLD supports a multi-link reconfiguration capability, feeding back a fourth frame to the first MLD, wherein the fourth frame is used to respond to the first frame; and
wherein information on whether the second MLD supports the multi-link reconfiguration capability is carried in a Common Information field of a multi-link reconfiguration (Reconfiguration Multi-Link) element or a Common Information field of a basic multi-link (Basic Multi-Link) element sent by the second MLD.

16. The communication method according to claim 15, wherein the fourth frame comprises eighth identification information, and the eighth identification information indicates whether the second MLD successfully accepts the TID mapping indicated in the first frame.

17. The communication method according to claim 16, wherein when the eighth identification information is set to a fourth parameter value, and the Reconfiguration Multi-Link element of the first frame indicates that the first frame is used for a newly added link, an STA information field of the Reconfiguration Multi-Link element comprises an indication subfield, and the indication subfield comprises a transmission type of added link.

18. (canceled)

19. The communication method according to claim 14, wherein the first identification information is carried in a Reconfiguration Multi-Link element of the first frame; and
the first identification information is carried in a STA Control field of the Reconfiguration Multi-Link element.

20. The communication method according to claim 19, wherein when the first identification information indicates mapping the target TID to the newly added link, an STA information field of the Reconfiguration Multi-Link element comprises second identification information, and
the second identification information indicates TID information on the newly added link.

21-28. (canceled)

29. An electronic device, comprising a memory, a processor, and a computer program stored in the memory and executable on the processor, wherein, when the program is executed by the processor, the method according to claim 1 is performed.

30. A computer-readable storage medium, wherein the computer-readable storage medium is stored with a computer program, and when the program is executed by a processor, the method according to claim 1 is performed.

31. An electronic device, comprising a memory, a processor, and a computer program stored in the memory and executable on the processor, wherein when the program is executed by the processor, the method according to claim 14 is performed.

32. A computer-readable storage medium, wherein the computer-readable storage medium is stored with a computer program, and when the program is executed by a processor, the method according to claim 14 is performed.
